(19) United States
(12) Patent Application Publication
(10) Pub. No.: US 2023/0166453 A1
(43) Pub. Date: Jun. 1, 2023

(54) CONTROLLING A THERMAL PARAMETER IN ADDITIVE MANUFACTURING

(71) Applicant: Hewlett-Packard Development Company, L.P., Spring, TX (US)

(72) Inventors: Wei Huang, Palo Alto, CA (US); William J. Allen, Corvallis, OR (US); Gary J. Dispoto, Palo Alto, CA (US)

(73) Assignee: Hewlett-Packard Development Company, L.P., Spring, TX (US)

(21) Appl. No.: 17/911,181

(22) PCT Filed: Apr. 9, 2020
(86) PCT No.: PCT/US2020/027486

§ 371 Date: Sep. 13, 2022

(51) Int. Cl. B29C 64/393; B29C 64/153; B33Y 10/00; B33Y 50/02

(52) U.S. Cl. CPC B29C 64/393; B29C 64/153; B33Y 10/00; B33Y 50/02

(57) ABSTRACT

A method includes additively manufacturing a three-dimensional object including a selectable parameter to control at least one thermal parameter of the three-dimensional object.

### BACKGROUND

Additive manufacturing may revolutionize design and manufacturing in producing three-dimensional (3D) objects. Some forms of additive manufacturing may sometimes be referred to as 3D printing. Such 3D objects may exhibit various mechanical properties.

### BRIEF DESCRIPTION OF THE DRAWINGS

FIG. 1 is a block diagram schematically representing an example method of additively manufacturing.

FIGS. 2A, 2B are diagrams schematically representing a portion of a 3D object with uniform solidification and with a selectable porosity to control a thermal parameter, respectively.

FIG. 3 is a block diagram schematically representing an example device to additively manufacture 3D objects.

FIG. 4A is diagram including a sectional view schematically representing an example portion of a 3D object.

FIG. 4B is diagram including a sectional view schematically representing an example portion of a 3D object.

FIG. 5 is a diagram including an isometric view schematically representing an example 3D object including an embedded structure and adjacent selectable portion.

FIG. 6A is diagram including a sectional view schematically representing an example portion of a 3D object including anisotropic thermal conductivity profile.

FIG. 6B is diagram including a sectional view schematically representing an example portion of a 3D object implementing a thermal parameter according to a spatially varying arrangement.

FIG. 7A is block diagram schematically representing a 3D object formation engine.

FIG. 7B is block diagram schematically representing an example control portion.

FIG. 7C is a block diagram schematically representing an example user interface.

FIG. 8 is flow diagram schematically representing an example method of additive manufacturing.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

At least some examples of the present disclosure provide for additively manufacturing a 3D object while controlling at least one thermal parameter of at least selectable portion of the 3D object. In some examples, the at least one thermal parameter may comprise thermal conductivity, heat capacity, and/or specific heat capacity. In some examples, such control is implementable according to a selectable parameter, such as implementing a selectable porosity, density, and/or degree of fusion (e.g. solidification) of a build material of the 3D object. For example, because more porous (i.e. less dense) materials generally provide for lower thermal conductivity as compared to non-porous or less porous (i.e. more dense) materials, by implementing a selectable porosity of at least a selectable portion of a 3D object, one can control or influence the thermal conductivity of the selectable portion or the 3D object as a whole. In some such examples in which a build material of the 3D object comprises a powder material, a selectable porosity can be implemented by controlling a degree of fusion of the build material, which in turn is implemented by controlling a volume and/or location of fusing agents, detailing agents, etc. applied to deposited build material prior to applying energy (e.g. radiation) to fuse or solidify the build material. In some examples, a porosity may sometimes be referred to, or expressed as, as spatial variation in fusion attributes.

In some examples, a selectable degree of density depends on, and is related to the degree of fusion. For instance, in some examples, an unfused powder build material may exhibit a density about one-half the value of a density of a fully fused powder build material. Consequently, in some such examples, a build material which is fifty percent fused may exhibit a density approximately between these two values of density.

In some examples, control or modification of at least one thermal parameter of a 3D object during additive manufacturing can be implemented without changing a type of the build material and/or without a changing a geometric boundary of the 3D object.

Via at least some examples of the present disclosure, one can construct a 3D object with desired thermal parameter(s) so that a particular 3D object, or portion thereof, can either enhance or reduce heat transfer through the 3D object (or portion thereof).

In some examples, a user can select the desired thermal parameter(s) for a 3D object (or portion thereof), such as via a user specification design tool displayable in a user interface. Using the user-specified value of a desired thermal parameter, an example device and/or example method may automatically determine appropriate values of a porosity, density, and/or degree of fusion, which will produce the user-selected, desired thermal parameter within the 3D object (or portion thereof).

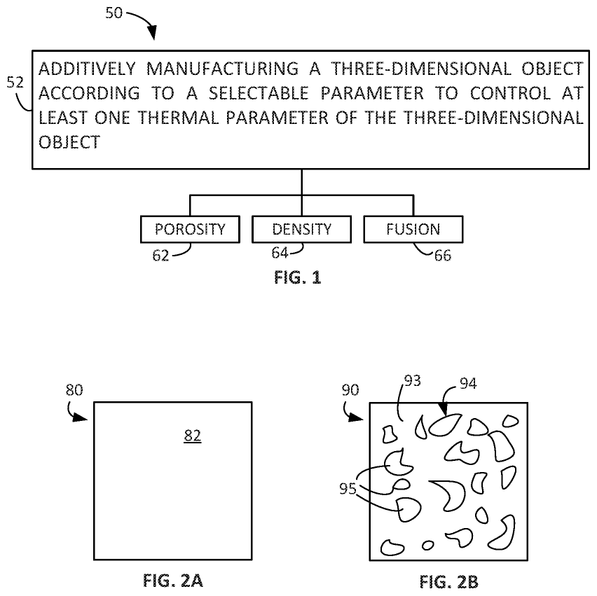

These examples, and additional examples, are further described in association with at least FIGS. 1-8.

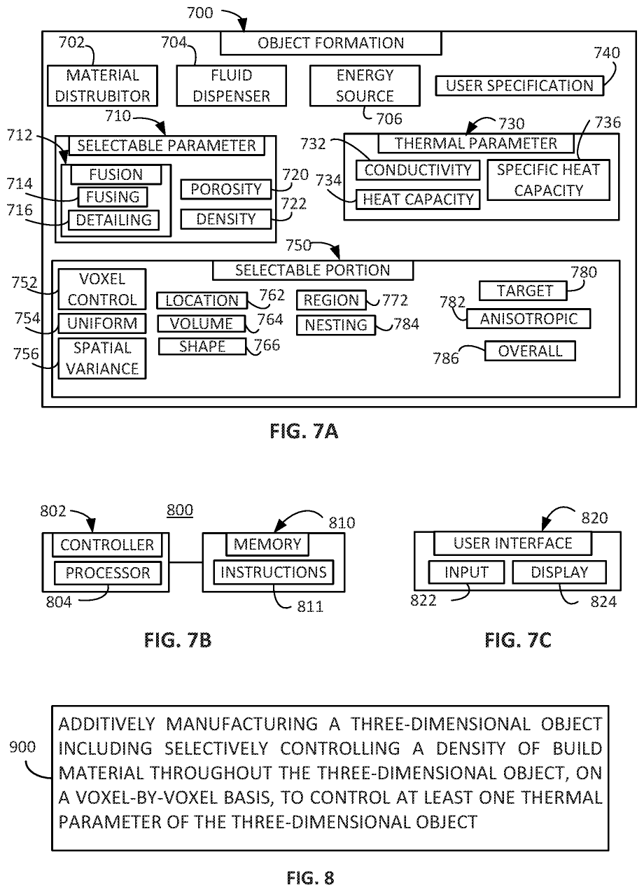

FIG. 1 is a block diagram schematically representing an example method 50 of additively manufacturing an example 3D object. As shown at 52 in FIG. 1, method 50 comprises additively manufacturing a three-dimensional object according to a selectable parameter to control at least one thermal parameter of the three-dimensional object. In some examples, a value of the at least one thermal parameter may be user-selectable. As further shown in FIG. 1, in some examples, the selectable parameter may comprise at least one of a porosity (62), a density (64), and a degree of fusion (66) associated with a build material used to additively form the 3D object. In some examples, the degree of fusion may sometimes be referred to as a degree of solidification. In some examples in which the value(s) of the at least one thermal parameter may be user-specified, an example method and/or example device may implement a porosity, density, and/or degree of fusion in order to produce the user-selected value of the at least one thermal parameter. In some examples, such user selection of a value of at least one thermal parameter may be implemented via a user specification engine (e.g. 740 in FIG. 7A), which is engageable by the user via a user interface (e.g. 820 in FIG. 7C).

FIG. 2A is a diagram including a sectional view schematically representing a portion 82 of an example 3D object 80 which exhibits generally uniform solidification of a build material used in forming the 3D object. In some such examples, the build material has been fully fused, melted, etc. and/or otherwise exhibits a generally uniform first density. Such an arrangement will exhibit a first thermal parameter, such as a particular thermal conductivity, heat capacity and/or specific heat capacity. However, in some examples, a generally uniform density also may be achieved via partially fusing or partially solidifying the build material, provided that the relative degree of fusion is generally uniform throughout the 3D object.

In general terms, thermal conductivity corresponds to the ability of a body to conduct heat such that a high thermal conductivity would correspond to a body which readily conducts heat while a body with a lower thermal conductivity would correspond to a body which poorly conducts heat. In one aspect, the thermal conductivity is measurable as Watts per meter (Kelvin). In general terms, heat capacity corresponds to an amount of heat to be supplied to a given object (e.g. mass of a material) to produce a unit change in its temperature, and which is measurable in joules per Kelvin, in some examples. In some instances, a heat capacity may be referred to as a thermal capacity, which corresponds to a property of a material to absorb heat when it is heated and to release heat when it is cooled. In general terms, a specific heat capacity corresponds to an amount of heat energy supplied to raise the temperature of a substance per unit of mass, and which is measurable in joules per Kelvin kg, in some examples.

In contrast to the arrangement of FIG. 2A, in some examples a similar portion 90 of an example 3D object shown in the sectional view of FIG. 2B exhibits a second density different from (e.g. less) than the first density of the portion 82 in FIG. 2A. As shown in FIG. 2B, a value of the second density is related to, and/or caused by, a porous structure present within portion 90. In some examples, this porosity may be referred to as a second porosity whereas the porosity (having a value of low value) of the portion 82 in FIG. 2A may be referred to as having a first porosity. As shown in FIG. 2B, the second porosity is represented in FIG. 2B by a plurality 94 of air pockets 95 dispersed throughout a build material 93. In some examples, the portion 90 in FIG. 2B comprises build material which has not been fused or just partially unfused, such that a significant degree of porosity is exhibited within the portion 90, whereas the portion 82 in FIG. 2A may comprise build material which has been fully fused or substantially fused uniformly throughout the portion 82 such that it is relatively homogenous.

Because of its increased porosity, the portion 90 in FIG. 2B exhibits different thermal parameters (e.g. conductivity, heat capacity, specific heat capacity) from the portion 82 in FIG. 2A.

For example, one type of powder build material 93 may exhibit a thermal conductivity of 0.231 W/m*K, whereas air (at 0 degrees C.) may exhibit a thermal conductivity of 0.024 W/m*K. When both the powder build material 93 and air are mixed together, such as in an unfused or partially fused state, then the thermal conductivity of the aggregation of air and powder build material will be less than the thermal conductivity of solely the power build material 93. Accordingly, by controlling the amount of air or porosity within the build material 93, one can control the relative thermal parameters (e.g. conductivity, heat capacity, specific heat capacity) of the 3D object (or selectable portion thereof). In some examples, the amount of air or porosity may be controlled according to a proportion of unfused build material and at least partially fused build material, which in turn selectively controls a density of the selectable portion of the 3D object. It will be understood that in some examples, during the additive manufacturing process, an inert gas (e.g. nitrogen) may be used in place of air or the inert gas may be mixed with the air.

With this in mind, via at least some examples of the present disclosure, the degree of the porosity exhibited in portion 90 in FIG. 2B may be selectively controlled. In some such examples, this selective control of porosity (and therefore an associated thermal parameter) may be implemented by a selectable degree of fusion (e.g. solidification) of the build material 93 deposited to form the 3D object. In turn, in some examples the selectable degree of fusion is implemented by controlling the application of fusing agents and/or detailing agents onto the build material, such as a powder-type of build material. If a fusing agent and/or detailing agent are not applied to at least some portions of the build material, then upon application of an energy source to those portions, the build material will remain unfused and therefore more porous than if it were fused. For instance, a powder build material would remain in a free powder state.

Moreover, if a volume of a fusing agent were applied at a much lower volume than a full volume (which would otherwise result in full solidification as in FIG. 2A), then the build material would partially fused and more porous than if fully fused. Similarly, adjustments to a volume of detailing agent may be made to affect the degree of fusion in a desired manner. It will be further understood that in some examples, solely a fusing agent (i.e. without a detailing agent) may be used to control a degree of fusion.

With this in mind, by controlling the volume of fusing agents and/or detailing agents applied to a particular portion of build material, one can control a degree of fusion and therefore control a degree of porosity of the particular portion, which in turn provides selective control regarding a thermal parameter (e.g. conductivity, heat capacity, specific heat capacity) of the portion of build material (and therefore 3D object).

It will be understood that this selective control of at least one thermal parameter of the portion 90 of a 3D object may be implemented without changing the type or volume of build material for that particular portion (for which thermal parameters are being controlled or modified) and/or without changing a boundary geometry of the particular portion (for which thermal parameters are being controlled or modified).

It will be understood that in some examples other additive manufacturing techniques (e.g. Fused Deposition Modeling (FDM), LaserProFusion, Selective Laser Sintering (SLS), Selective Laser Melting (SLM), 3D binder jetting, Electron Beam Melting (EBM), ProJet Fusion, etc.) may be used for form a 3D object. In such arrangements, the selectable parameter (e.g. porosity, density, fusion) and resulting thermal parameter in the portion 90 (according to examples of the present disclosure) may be implemented according to the particular build materials, application techniques, curing techniques, etc. associated with each particular modality of manufacturing.

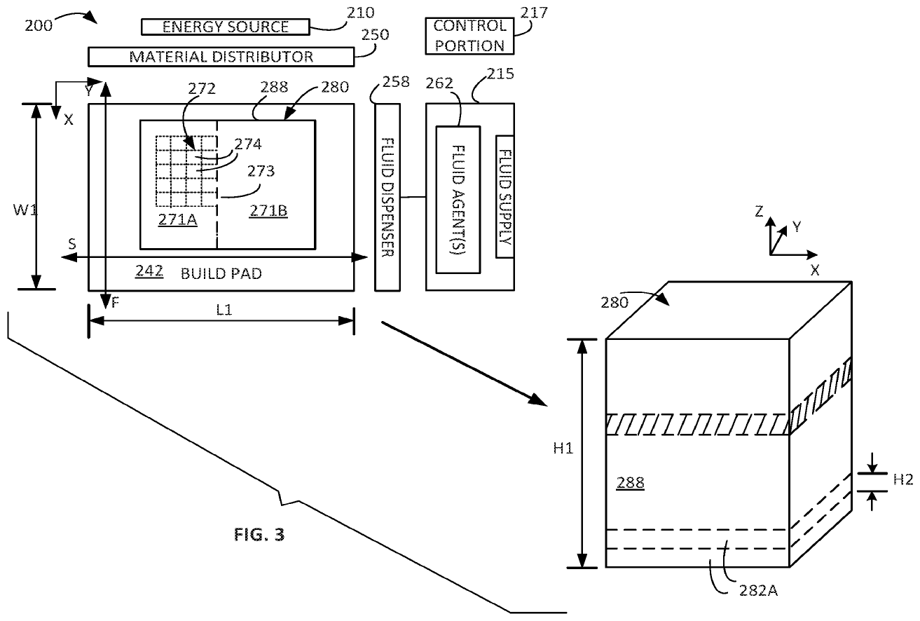

FIG. 3 is a diagram schematically representing an example device 200 to additively manufacture an example 3D object 280 by which selective control of a thermal parameter for the 3D object may be implemented. As shown in FIG. 3, in some examples, the device 200 comprises a material distributor 250 and a fluid dispenser 258. The material distributor 250 is arranged to dispense a build material layer-by-layer onto a build pad 242 to additively form the 3D object 280. Once formed, the 3D object 280 may be separated from the build pad 242. It will be understood that a 3D object of any shape and any size can be manufactured, and the object 280 depicted in FIG. 3 provides just one example shape and size of a 3D object. In some instances device 200 may sometimes be referred to as a 3D printer. Accordingly, the build pad 242 may sometimes be referred to as a print bed or a receiving surface.

It will be understood that the material distributor 250 may be implemented via a variety of electromechanical or mechanical mechanisms, such as doctor blades, slot dies, extruders, and/or other structures suitable to spread, deposit, and/or otherwise form a coating of the build material in a generally uniform layer relative to the build pad 242 or relative to a previously deposited layer of build material.

In some examples, the material distributor 250 has a length (L1) at least generally matching an entire length (L1) of the build pad 242, such that the material distributor 250 is capable of coating the entire build pad 242 with a layer 282A of build material in a single pass as the material distributor 250 travels the width (W1) of the build pad 242. In some examples, the material distributor 250 can selectively deposit layers of material in lengths and patterns less than a full length of the material distributor 250. In some examples, the material distributor 250 may coat the build pad 242 with a layer 282A of build material(s) using multiple passes instead of a single pass.

It will be further understood that a 3D object additively formed via device 200 may have a width and/or a length less than a width (W1) and/or length (L1) of the build pad 242.

In some examples, the material distributor 250 moves in a first orientation (represented by directional arrow F) while the fluid dispenser 258 moves in a second orientation (represented by directional arrow S) generally perpendicular to the first orientation. In some examples, the material distributor 250 can deposit material in each pass of a back-and-forth travel path along the first orientation while the fluid dispenser 258 can deposit fluid agents in each pass of a back-and-forth travel path along the second orientation. In at least some examples, one pass is completed by the material distributor 250, followed by a pass of the fluid dispenser 258 before a second pass of the material distributor 250 is initiated, and so on.

In some examples, the material distributor 250 and the fluid dispenser 258 can be arranged to move in the same orientation, either the first orientation (F) or the second orientation (S). In some such examples, the material distributor 250 and the fluid dispenser 258 may be supported and moved via a single carriage while in some such examples, the material distributor 250 and dispenser 258 may be supported and moved via separate, independent carriages.

In some examples, the build material used to generally form the 3D object comprises a polymer material. In some examples, the polymer material comprises a polyamide material. However, a broad range of polymer materials (or their combinations) may be employed as the build material. In some examples, the build material may comprise a ceramic material. In some examples, the build material may take the form of a powder while in some examples, the build material may take a non-powder form, such as liquid or filament. Regardless of the particular form, at least some examples of the build material is suitable for spreading, depositing, extruding, flowing, etc. in a form to produce layers (via material distributor 250) additively relative to build pad 242 and/or relative to previously formed first layers of the build material.

In some examples, the fluid dispenser 258 shown in FIG. 3 comprises a printing mechanism, such as an array of printheads, each including a plurality of individually addressable nozzles for selectively ejecting fluid agents onto a layer of build material. Accordingly, in some examples, the fluid dispenser 258 may sometimes be referred to as an addressable fluid ejection array. In some examples, the fluid dispenser 258 may eject individual droplets having a volume on the order of ones of picoliters or on the order of ones of nanoliters.

In some examples, fluid dispenser 258 comprises a thermal inkjet (TIJ) array. In some examples, fluid dispenser 258 may comprise a piezoelectric inkjet (PIJ) array or other technologies such as aerosol jetting, anyone of which can precisely, selectively deposit a small volume of fluid. In some examples, fluid dispenser 258 may comprise continuous inkjet technology.

In some examples, the fluid dispenser 258 selective dispenses droplets on a voxel-by-voxel basis. In one sense a voxel may be understood as a unit of volume in a three-dimensional space. In some examples, a resolution of 1200 voxels per inch in the x-y plane is implemented via fluid dispenser 258. In some examples, a voxel may have a height H2 (or thickness) of about 100 microns, although a height of the voxel may fall between about 80 microns and about 100 microns. However, in some examples, a height of a voxel may fall outside the range of about 80 to about 100 microns. FIG. 3 also illustrates the fully formed 3D object 280 having a height H1.

In some examples, the height (H2) of the voxel may correspond to a thickness of one layer (e.g. 282A) of the build material.

In some examples, the fluid dispenser 258 has a width (W1) at least generally matching an entire width (W1) of the build pad 242, and therefore may sometimes be referred to as providing page-wide manufacturing (e.g. page wide printing). In such examples, via this arrangement the fluid dispenser 258 can deposit fluid agents onto the entire receiving surface in a single pass as the fluid dispenser 258 travels the length (L1) of the build pad 242. In some examples, the fluid dispenser 258 may deposit fluid agents onto a given layer of material using multiple passes instead of a single pass.

In some examples, fluid dispenser 258 may comprise, or be in fluid communication with, an array of reservoirs to contain various fluid agents 262. In some examples, the array of reservoirs may comprise a fluid supply 215. In some examples, the fluid supply 215 comprises reservoirs to hold various fluids, such as a carrier (e.g. ink flux) by which various agents may be applied in a fluidic form.

In some examples, at least some of the fluid agents 262 may comprise a fusing agent, a color agent, detailing agent, etc. to enhance formation of each layer 282A of build material. In particular, upon application onto the build material at selectable positions via the fluid dispenser 258, the respective fusing agent and/or detailing agent may diffuse, saturate, and/or blend into the respective layer of the build material at the selectable positions. As noted elsewhere, a volume and/or location of application of the fusing agent and/or detailing agent on particular portions of the build material may be used to selectively control a degree of fusion (e.g. solidification), porosity, and/or density of the build material and therefore modify or control at least one thermal parameter (e.g. conductivity, heat capacity, specific heat capacity) of the particular portions of the build material. Moreover, by controlling these characteristics of the particular portions, one may control at least one thermal parameter of the entire 3D object or portions thereof. As noted elsewhere in the present disclosure, in some examples a user may first select the desired value(s) of the thermal parameter to be achieved for the entire 3D object (or selectable portion thereof) with the appropriate porosity, density, and/or degree of fusion being automatically implemented by an example method and/or device in order to achieve the selected value of the thermal parameter.

As further shown in FIG. 3, in some examples, the at least partially formed 3D object 280 comprises a first portion 271A and a second portion 271B with dashed line 273 representing a boundary between the first portion 271A and the second portion 271B. The 3D object 280 may comprise an exterior side surface 288.

During formation of a desired number of layers 282A of the build material, in some examples the fluid dispenser 258 may selectively dispense droplets of fluid agent(s) 262 at some first selectable voxel locations 274 of at least some respective layers 282A to at least partially define the first portion 271A of the 3D object. It will be understood that a group 272 of first selectable voxel locations 274, or multiple different groups 272 of first selectable voxel locations 274 may be selected in any position, any size, any shape, and/or combination of shapes.

In some examples, the at least some first selectable voxel locations 274 may correspond to an entire layer 282A of a 3D object or just a portion of a layer 282A. Meanwhile, in some examples, the 3D object may comprise a part of a larger object. In some examples, each first selectable voxel location 274 corresponds to a single voxel.

As further shown in FIG. 3, in some examples device 200 comprises an energy source 210 for applying energy (e.g. irradiating) to the deposited build materials, fluid agents (e.g. fusing agent, detailing agent, etc.) to cause heating of the material, which in turn results in the fusing of particles of the material relative to each other, with such fusing occurring via melting, sintering, etc. In portions of the 3D object in which full solidification is desired, such as for structural purposes, then an appropriate volume of the respective fusing agents and/or detailing agents are applied to those portions of the 3D object. However, as noted elsewhere previously, in portions of the 3D object for which a modification at least one thermal parameter (e.g. conductivity, heat capacity, specific heat capacity) is to be implemented, then a lower volume of the respective fusing agent(s) are to be applied and/or adjustments to a volume of the detailing agents(s) are to made.

After application of the radiation from energy source 210, a layer 282A of build material is formed and additional layers 282A of build material may be formed in a similar manner as represented in FIG. 3. In view of the foregoing examples, it will be understood that any given formed layer 282A of build material may include at least some portions which are unfused or partially fused in order to achieve the target thermal parameter objectives.

In some examples, the energy source 210 may comprise a gas discharge illuminant, such as but not limited to a Halogen lamp. In some examples, the energy source 210 may comprise multiple energy sources. As previously noted, energy source 210 may be stationary or mobile and may operate in a single flash or multiple flash mode.

As shown in FIG. 3, in some examples device 200 may comprise a control portion 217 to direct operations of device 200. In some examples, control portion 217 may be implemented via at least some of substantially the same features and attributes as control portion 800, as later described in association with at least FIG. 7B.

In some examples the device 200 can be used to additively form a 3D object via a powder bed-based process, such as MultiJet Fusion (MJF) process (available from HP, Inc.). In some examples, an additive manufacturing process performed via device 200 may omit at least some aspects of and/or may include at least some aspects of: selective laser sintering (SLS); selective laser melting (SLM); 3D binder printing (e.g. 3D binder jetting); electron-beam melting (EBM); fused deposition modeling (FDM); multi-jet printing (e.g. ProJet Fusion); LaserProFusion; stereolithography (SLA); or curable liquid photopolymer jetting (Polyjet).

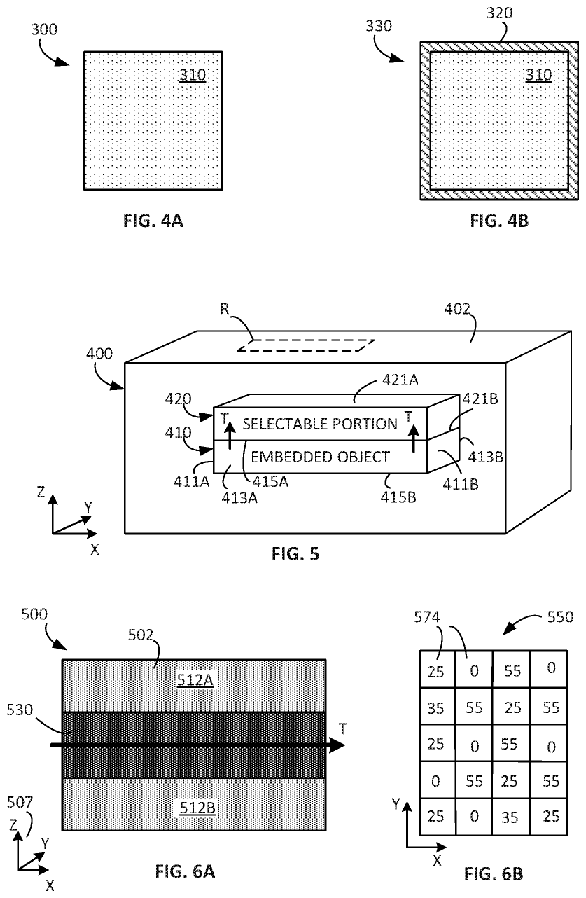

FIG. 4A is a diagram schematically representing an example portion 310 of at least partially formed 3D object 300 with a selectable parameter (e.g. porosity, density, degree of fusion) to control at least one thermal parameter of at least portion 310 of the 3D object 300. In some examples, the portion 310 comprises substantially the entire volume of the 3D object such that the controlled at least one thermal parameter acts to control a bulk thermal parameter of the 3D object.

As shown in FIG. 4B, in some examples, a 3D object 330 includes a portion 310 like portion 310 in the example of FIG. 4A, except with 3D object 330 further comprising an exterior portion 320 at least partially surrounding the portion 310 (e.g. interior portion). One example of the arrangement in FIG. 4B corresponds to the exterior portion 320 comprising fully fused or at least partially fused build material, which forms a shell to contain the interior portion 310, with the interior portion 310 comprising at least one of an unfused build material and at least partially fused material. In some examples, the exterior portion 320 includes build material which is not fully fused, but which exhibits a greater degree of fusion (i.e. solidification) than in interior portion 310. In some examples, none of the build material in interior portion 310 is fused, resulting in maximizing the porosity exhibited within the unfused build material, and therefore significantly reducing the value of a thermal parameter (e.g. conductivity, heat capacity, specific heat capacity) for the entire portion 330 of the 3D object. In some examples, the thermal parameter exhibited by the interior portion 310 of portion 330 may sometimes be referred to as a bulk thermal parameter.

In some examples in which the exterior portion 320 acts as a shell to contain the interior portion 310, the exterior portion 320 may comprise a different thermal parameter from the interior portion 310. However, in some such examples in which the exterior portion 320 comprises a relatively small volume, such as via a minimal thickness compared to the overall volume of the 3D object 330, the effect of the different thermal parameter of exterior portion 320 may be negligible, i.e. does not generally affect the bulk thermal parameter (e.g. conductivity, etc.) of the interior portion 310.

In some examples, forming a 3D object (e.g. 330) with an interior portion 310 having a lower thermal conductivity due to a significant volume of unfused or underfused build material may be used to inhibit thermal transfer by objects, structures, etc. adjacent to the 3D object. As previously noted, by controlling a degree of fusion of the build material in the interior portion 310, one can control a value of at least one thermal parameter (e.g. conductivity, heat capacity, specific heat capacity).

As shown in FIG. 5, in some examples an at least partially formed 3D object may comprise an embedded structure 410 and a selectable portion 420 adjacent the embedded structure 410. In some examples, the embedded structure 410 may be formed at the same time as and/or via the same additive manufacturing device 200 (FIG. 3) forming the 3D object 400. In some examples, the embedded structure 410 may comprise an object not additively manufactured, which is placed within an at least partially additively manufactured 3D object. In either case, in some such examples the embedded structure 410 may comprise properties and/or operating characteristics which generate heat and/or generate cooling, which may result in thermal transfer relative to nearby portions of the 3D object 400.

In some examples, the selectable portion 420 comprises a top surface portion 421A and an opposite bottom surface portion 421B.

In some examples, the selectable portion 420 may be in contact against the embedded structure 410. In some examples, the selectable portion 420 may be adjacent to, but spaced apart from, the embedded structure 410. As shown in FIG. 5, in some examples, the bottom surface portion 421B of the selectable portion 420 is sized and shaped to be in contact with a top side 415A of the embedded structure.

In some examples, the selectable portion 420 comprises a portion of at least partially formed 3D object 400 which is selectively manufactured according to at least one parameter which may complement the thermal properties of the embedded structure 410. For example, the selectable portion 420 may comprise a selectable porosity, selectable density, and/or selectable degree of fusion in order to cause the selectable portion to exhibit at least one thermal parameter (e.g. conductivity, heat capacity, specific heat capacity). As noted previously, in some examples a user may select a desired value of the at least one thermal parameter from which an example method and/or device then implements a corresponding porosity, density, and/or degree of fusion in order to achieve the user-specified value of the at least one thermal parameter.

For example, at least a portion (e.g. topside 415A) of the embedded structure 410 may produce heat at a rate or quantity which may negatively affect performance of the embedded structure 410 if the heat is not sufficiently dissipated or externalized. In such situations, the selected portion 420 may be implemented with at least one thermal parameter in order to act as a heat sink to facilitate thermal transfer out of the embedded structure 410, which may act to protect or increase the performance of the embedded structure 410. In some examples, the embedded structure 410 may comprise electronic circuitry, a Peltier device, or other mechanisms which may generate heat and/or cooling.

It will be understood that the selectable portion 420 may comprise any shape, any volume, and/or any location (within the 3D object 400) suited for its purpose in complementing (e.g. influencing, responding to, etc.) thermal transfer in relation to the embedded structure 410.

In some examples, the selectable portion 420 may comprise a plurality of selectable portions 420 arranged within and throughout the 3D object to achieve the desired thermal transfer objective in relation to the embedded structure 410. In some examples, the selectable portion 420 may completely surround the embedded structure 410, while in some examples, the selectable portion 420 may partially surround the embedded structure 410, such as surrounding a selectable number of sides, surfaces, end, etc. (e.g. 411A, 411B, 413A, 413B, 415A, 415B) of the embedded structure 410.

In some examples, the selectable portion 420 (having a selectable thermal parameter) may comprise a volume, shape, and/or location such that at least a portion of the selectable portion is exposed at an external surface 402 of the 3D object, as represented by dashed box R. In some such examples, such an arrangement may be used to facilitate a thermal transfer objective relative to the embedded structure 410. It will be understood that in some examples such a selectable portion (e.g. at least partially exposed on an external surface R) may have a volume, shape, location to be in contact with (or closely adjacent to) other selectable portions (having a particular thermal parameter) and/or in contact with (or closely adjacent to) the embedded structure 410 to achieve desired thermal transfer objectives. One such thermal transfer objective may comprise providing a path for heat to be transferred from embedded structure to an exterior portion (R) of the 3D object 400.

FIG. 6A is a diagram including a sectional view schematically representing at least a portion 502 of an example 3D object 500 comprising a selectable parameter (e.g. porosity, density, fusion) to control at least one thermal parameter of at least the portion of the 3D object and/or the 3D object as a whole. As shown in FIG. 6A, at least a portion 502 of an example 3D object 500 comprises an interior portion 530 sandwiched between two outer portions 512A, 512B. The two outer portions 512A, 512B comprise a first thermal conductivity, while the interior portion 530 comprises a second thermal conductivity different from the first thermal conductivity, such that the overall portion 502 exhibits anisotropic thermal conductivity. In some such examples, the second thermal conductivity is greater than the first thermal conductivity such that the interior portion 530 will effectively act as a thermal transfer conduit, as represented via directional arrow T. Of course, to achieve other thermal transfer objectives, in some examples, the second thermal conductivity may be less than the first thermal conductivity.

Moreover, in some examples, each of the respective different portions 512A, 5128, 530 (of portion 502 of 3D object 400) may have a different thermal parameter (e.g. conductivity) arranged relative to each other to achieve a particular thermal transfer objective.

With further reference to the X,Y,Z axis indicator 507 in FIG. 6A, it will be understood that the anisotropy of thermal parameters of the portion 502 of the 3D object 500 (or the whole 3D object) may occur in any single orientation (or multiple orientations) within or throughout the 3D object 500. Moreover, some regions of a 3D object may comprise at least one first selectable portion comprising a first anisotropy of thermal parameters while other regions of the 3D object may comprise at least one second selectable portion 420, which comprises a different, second anisotropy of thermal parameters.

It will be understood that in some examples, the values of the thermal parameters and/or desired anisotropy profile may be selectable by the user, such as via a user-specification tool or engine via a user interface, and from which an example method and/or device implements a corresponding porosity, density, and/or degree of fusion to achieve the user-selected value or anisotropic profile of the thermal parameters.

FIG. 6B is a diagram schematically representing a two-dimensional view of an example portion 550 of a 3D object. As shown in FIG. 6B, in some examples the voxel locations 574 are arranged to implement a selectable parameter (e.g. porosity, density, fusion) according to a spatially-varying pattern to achieve an overall value or bulk value of a thermal parameter (e.g. conductivity, heat capacity, specific heat capacity) for a selectable portion of a 3D object. In a manner similar to other examples, the user may first select the overall value (e.g. bulk value) via a user-specification tool or engine (e.g. 740 in FIG. 7A) prior to an automatic implementation of such values according to a corresponding pattern of different values of porosity, density, and/or degree of fusion.

In some such examples, instead of all or most of the voxel locations 574 having the same or similar value of porosity (or density, degree of fusion), the voxel locations 574 of the selectable portion 550 are implemented to have a pattern of mixed values of porosity (or density, degree of fusion). As shown in FIG. 6B, assuming that a porosity, density, or degree of fusion is assigned a value on a scale from 0 to 100, then some voxel locations 574 may have a first value (e.g. 0), some voxel locations may have a second value (e.g. 25), some voxel locations may have a third value (e.g. 35), some voxel locations may have a fourth value (e.g. 55), and so on with the overall pattern of such values and respective locations resulting in an overall value (e.g. 27.5) for the selectable portion 550. In some examples, the overall value may be an average of the values from the different voxel locations, which in some examples, the overall value may be implemented according to other values, such as a mean, median, etc. In some examples, this arrangement of using different values among the voxel locations to achieve an overall value may be implemented via overall parameter 786 in selectable portion engine 750 in FIG. 7A.

If the values are used to refer to a degree of fusion, then a value of 0 would correspond to an unfused voxel location while a value of 100 would correspond to a fully fused voxel location, and values between 0 and 100 corresponding to a partially fused voxel location. When referring to a degree of porosity or density, the range of values of 0 to 100 represent a unit-less scale by which one may select a relative amount of porosity or density to enable achieving a desired thermal parameter (e.g. conductivity, heat capacity, specific heat capacity).

While the selectable portion 570 shown in FIG. 6B is viewed in two dimensions (e.g. X and Y), it will be understood that a selectable portion 570 also would extend in the third dimension (e.g. Z) such that the arrangement represented in FIG. 6B is in reality a three-dimensional arrangement.

It will be understood that the values representing a range of different porosities (or density, fusion, etc.) may be expressed as continuous range of values (such as an analog scale) between 0 and 100, and not merely as discrete values (e.g. 1, 2, 3 etc.). This arrangement also would be applicable to implementing or expressing a range of values of thermal parameters throughout an entire 3D object (or portion thereof).

FIG. 7A is a block diagram schematically representing an example object formation engine 700. In some examples, the object formation engine 700 may form part of a control portion 800, as later described in association with at least FIG. 7B, such as but not limited to comprising at least part of the instructions 811. In some examples, the object formation engine 700 may be used to implement at least some of the various example devices and/or example methods of the present disclosure as previously described in association with FIGS. 1-6B and/or as later described in association with FIGS. 7B-8. In some examples, the object formation engine 700 (FIG. 7A) and/or control portion 800 (FIG. 7B) may form part of, and/or be in communication with, an object formation device.

As shown in FIG. 7A, in some examples the object formation engine 700 may comprise a material distributor engine 702, fluid dispenser engine 704, and energy source engine 706.

As shown in FIG. 7A, in some examples the material distributor engine 702 controls distribution of layers of build material relative to build pad (e.g. 242 in FIG. 3) and/or previously deposited layers of build material. In some examples, the material distributor engine 702 comprises a material parameter to specify which material(s) and the quantity of such material which can be used to additively form a body of the 3D object. In some examples, these materials are deposited via build material distributor 250 of device 200 (FIG. 3).

In some examples, the material controlled material distributor engine 702 may comprise polymers, ceramics, etc. having sufficient strength, formability, toughness, etc. for the intended use of the 3D object with at least some example materials being previously described in association with at least FIG. 3.

As shown in FIG. 7A, in some examples the fluid dispenser engine 704 may specify which fluid agents are to be selectively deposited onto a layer (or portions of a layer) of build material. In some examples, such agents are deposited via fluid dispenser 258 (FIG. 3). In some examples, the fluid dispenser engine 704 may comprise a carrier function and an agent function to apply fluid agents, such as the carrier, fusing, detailing, etc. as previously described in association with at least FIG. 3. In particular, via the fluid dispenser engine 704, application of a selectable volume (and location) of a fusing agent and/or detailing agent may be used to selectably control a degree of fusion at selectable voxel locations, and therefore control a porosity (and density) of a portion of a 3D object, which in turn provides control over a value of thermal parameter. In some examples, fluid dispenser engine 704 may specify a number of fluid application channels, volume of fluid to be applied, during which pass the particular fluid channel is active, etc.

In some examples, the energy source engine 706 of manufacturing engine 700 is to control operations of at least one energy source (e.g. 210 in FIG. 3). In some examples, the energy source engine 706 may control an amount of time that energy from the radiation source 210 (FIG. 3) emitted toward the material, agents, etc. on a layer of build material, with a degree of fusion depending on a volume (and location) of fusing agent(s) and/or detailing agent(s) applied at particular voxel locations. In some examples, the energy source may irradiate the targeted layer (of the 3D object under formation) in a single flash or in multiple flashes. In some examples, the energy source may remain stationary (i.e. static) or may be mobile. In either case, during such irradiation, the energy source engine 706 controls the intensity, volume, and/or rate of irradiation.

As further shown in FIG. 7A, in some examples, the object formation engine 700 comprise a selectable parameter engine 710, a thermal parameter engine 730, and a selectable portion engine 750.

In some examples, the selectable parameter engine 710 is to track and/or control at least one of a degree of fusion (parameter 712), a degree of porosity (parameter 720, and a degree of density (parameter 722) for a selectable portion of a 3D object. In some examples, the selectable portion may comprise the whole 3D object, while in some examples the selectable portion may comprise just a portion or just some portions of the whole 3D object.

In some examples, in cooperation with the fluid dispenser engine 704, the degree of fusion parameter 712 may provide control over a fusing agent parameter 714 and/or a detailing agent parameter 716, which in turn control a volume and location at which a fusing agent and/or a detailing agent, respectively, are deposited onto a build material. The relative volume of the fusing agent and/or detailing agent deposited to a particular voxel location (e.g. 274) determines a degree of fusion (712) of the particular voxel location, as previously described in association with at least FIGS. 3-6B. In particular, in the absence of fusing agent and/or detailing applied to a particular voxel location and upon application of radiation per energy source (e.g. 210 in FIG. 3), no fusion will take place for the particular voxel location 274 (FIG. 3). This arrangement, in turn, will result in increased porosity 720 (and lower density 722) for the voxel location(s) 274 because of the generally greater porosity (and less density) exhibited by unfused build material, i.e. free powder. On the other hand, upon depositing a selectable volume of fusing agent and/or detailing agent to a particular voxel location(s) 274, one can control a degree of fusion of the build material at the particular voxel location(s) 274, and thereby control a porosity 720 and density 722 at that particular voxel location(s) 274 of the 3D object. Via this arrangement, the particular voxel location(s) 274 may become at least partially fused and in some instances, fully fused. As noted previously, by controlling the degree of porosity (and therefore density), this arrangement provides control over at least one thermal parameter (engine 730) of the particular voxel location(s) 274, and therefore over at least a selectable portion of the 3D object, if not the whole 3D object.

As previously described in various examples of the present disclosure, in some examples a user may first select a desired value of a thermal parameter per a user specification engine 740, as shown in FIG. 7A. From this user-selected value, the object formation engine 700 may then automatically implement additive manufacturing according to an appropriate porosity, density, and/or degree of fusion (in the manner described above) in order to achieve the user-selected value of the thermal parameter. It will be further understood that in some examples, the user specification engine 740 (or tool) may be engaged by a user to specify values of other parameters, functions, operation of various engines, etc. of the object formation engine 700 or to control various aspects of the example methods and/or devices of the present disclosure.

As further shown in FIG. 7A, the object formation engine 700 comprises a thermal parameter engine 730 which is to control, in cooperation with the selectable parameter engine 710, at least one thermal parameter of a selectable portion of a 3D object. In some examples, the at least one thermal parameter comprises a thermal conductivity (parameter 732), a heat capacity (parameter 734), and/or a specific heat capacity (parameter 736) of a selectable portion of a 3D object, as previously described in association with at least FIGS. 1-6B.

In general terms, the selectable portion 750 of manufacturing engine 700 enables the selection of attributes by which the selected fluid agents are deposited via fluid dispenser engine 704 in a manner which at least partially controls at least one thermal parameter (e.g. per engine 730) of the 3D object being formed. In some examples, a voxel control parameter 752 of the selectable portion engine 750 provides control on a voxel-by-voxel basis of a selectable parameter (710), such as porosity, density, fusion, which in turn provides control over at least one thermal parameter (730) of at least a selectable portion of an additively formed 3D object.

In some examples, the selectable portion engine 750 comprises an uniform parameter 754, which provides control to cause at least a selectable portion of the 3D object to exhibit an uniform or substantially uniform selectable parameter (e.g. porosity, density, fusion), which in turn, results in an uniform or substantially uniform at least one thermal parameter (730) of the at least selectable portion of the 3D object.

In some examples, the selectable portion engine 750 comprises a spatial variance parameter 756, which provides control to cause a value of a selectable parameter (e.g. porosity, density, fusion) to vary spatially within and/or throughout the selectable portion of the 3D object. For instance, via parameter 756, a value of the selectable parameter(s) may be implemented to be different at various voxel location(s) (e.g. 274 in FIG. 3) within and throughout the selectable portion of the 3D object. By doing so, the selectable portion engine 750 enables customizing, modifying, etc. at least one thermal parameter for selectable portion(s) of, or an entire, 3D object. Via the voxel control parameter 752 and spatial variance parameter 756, a particular selectable parameter (e.g. porosity, density, fusion) may be implemented for any particular voxel location (274 in FIG. 3) within the three-dimensional array of voxel locations for the 3D object. In some examples, this voxel level control and/or spatial variance control may sometimes be referred to as, and/or implemented via, a three-dimensional scalar field within the 3D object.

Among other possible example implementations of the voxel control parameter 752 and/or the spatial variance parameter 756, several example implementations associated with the selectable portion engine 750 are described below with at least parameters 762-786. Accordingly, in some examples, implementing a selectable parameter (e.g. porosity, density, fusion) according to spatial variance (756) may be implemented to as a selectable location (parameter 762), volume (parameter 764), and/or shape (parameter 766) of the selectable portion of the 3D object. In some such examples, the volume can be specified as an absolute volume or as a relative volume. In specifying the location, volume, and shape, the selectable portion engine 750 also may specify a quantity of multiple locations of selectable portions and/or a spacing between such multiple locations of selectable portions.

In some examples, the selectable portion engine 750 may implement a selectable portion in a region or plurality of regions (parameter 772). Meanwhile, in some examples, a selectable portion may be implemented via nesting parameter 784 by which a first portion is nested within a second portion of a 3D object, with each respective portion having a different value of a selectable parameter (710) to control at least one thermal parameter 730, such as but not limited to the previously described example implementation of FIG. 4B.

In some examples, the selectable portion engine 750 comprises a target parameter 780 to cause a selectable portion of a 3D object to have a selectable thermal parameter 730 (e.g. conductivity, heat capacity, specific heat capacity) in relation to an embedded structure. In some such examples, at least one thermal parameter (730) of the selectable portion may complement (e.g. influence, be influenced by, etc.) the embedded structure. In some such examples, the target parameter 780 may be implemented in a manner substantially the same as previously described in association with at least FIG. 5.

In some examples, the selectable portion engine 750 comprises an anisotropic parameter 782 to cause at least a selectable portion of a 3D object to exhibit anisotropic thermal parameters, e.g. a desired anisotropic profile. In some examples, the selectable portion exhibiting anisotropic thermal parameters may comprise the entire (or substantially the entire) 3D object. In some such examples, the anisotropic parameter 782 may be implemented in a manner comprising at least some of substantially the same features and attributes as previously described in association with at least FIG. 6A. Moreover, in some examples, the anisotropic parameter 782 may be implemented in a manner comprising at least some of substantially the same attributes as previously described in association with at least FIG. 4B, in which an exterior portion 320 exhibits different thermal parameters than an interior portion 310 due to the different porosity, density, degree of fusion of the exterior portion 320 as compared to the interior portion 310.

In some examples, selectable portion engine 750 comprises an overall parameter 786 to control implementation of at least a selectable portion of 3D object to exhibit at least one thermal parameter (e.g. conductivity, heat capacity, specific heat capacity) according to a voxel spatial variance arrangement by which different voxel location(s) (e.g. 274 in FIG. 3) within a selectable portion may have different degrees of fusion (e.g. fused, unfused, or partially fused) to achieve an overall value of the desired thermal parameter. In such arrangements, many of the voxel locations in the selectable portion exhibit a different degree of fusion. In some such examples, the overall thermal parameter 786 may be implemented in a manner substantially the same as previously described in association with at least FIG. 6B. It will be further understood that in some examples, such arrangements may be used to implement a 3D object with a thermal parameter which varies as a gradient or other spatially varying form.

It will be understood that various functions and parameters of object formation engine 700 may be operated interdependently and/or in coordination with each other, in at least some examples.

FIG. 7B is a block diagram schematically representing an example control portion 800. In some examples, control portion 800 provides one example implementation of a control portion (e.g. 217 in FIG. 3) forming a part of, implementing, and/or generally managing the example additive manufacturing devices, as well as the particular portions, components, material distributors, fluid supply, fluid dispensers, energy sources, control portion, instructions, engines, functions, parameters, and/or methods, as described throughout examples of the present disclosure in association with FIGS. 1-6 and 7B-8. In some examples, control portion 800 includes a controller 802 and a memory 810. In general terms, controller 802 of control portion 800 comprises at least one processor 804 and associated memories. The controller 802 is electrically couplable to, and in communication with, memory 810 to generate control signals to direct operation of at least some the object formation devices, various portions and elements of the example additive manufacturing devices, as well as the particular portions, components, material distributors, fluid supply, fluid dispensers, energy sources, control portion, instructions, engines, functions, parameters, and/or methods, as described throughout examples of the present disclosure. In some examples, these generated control signals include, but are not limited to, employing instructions 811 stored in memory 810 to at least direct and manage additive manufacturing of 3D objects in the manner described in at least some examples of the present disclosure. In some instances, the controller 802 or control portion 800 may sometimes be referred to as being programmed to perform the above-identified actions, functions, etc. In some examples, at least some of the stored instructions 811 are implemented as a, or may be referred to as, a 3D print engine, an object formation engine, and the like, such as but not limited to the object formation engine 700 in FIG. 7A.

In response to or based upon commands received via a user interface (e.g. user interface 820 in FIG. 7C) and/or via machine readable instructions, controller 802 generates control signals as described above in accordance with at least some of the examples of the present disclosure. In some examples, controller 802 is embodied in a general purpose computing device while in some examples, controller 802 is incorporated into or associated with at least some of the additive manufacturing devices, as well as the particular portions, components, material distributors, fluid supply, fluid dispensers, energy sources, control portion, instructions, engines, functions, parameters, and/or methods, etc. as described throughout examples of the present disclosure.

For purposes of this application, in reference to the controller 802, the term “processor” shall mean a presently developed or future developed processor (or processing resources) that executes machine readable instructions contained in a memory or that includes circuitry to perform computations. In some examples, execution of the machine readable instructions, such as those provided via memory 810 of control portion 800 cause the processor to perform the above-identified actions, such as operating controller 802 to implement the formation of a 3D object with particular thermal parameters as generally described in (or consistent with) at least some examples of the present disclosure. The machine readable instructions may be loaded in a random access memory (RAM) for execution by the processor from their stored location in a read only memory (ROM), a mass storage device, or some other persistent storage (e.g., non-transitory tangible medium or non-volatile tangible medium), as represented by memory 810. The machine readable instructions may include a sequence of instructions, a processor-executable machine learning model, or the like. In some examples, memory 810 comprises a computer readable tangible medium providing non-volatile storage of the machine readable instructions executable by a process of controller 802. In some examples, the computer readable tangible medium may sometimes be referred to as, and/or comprise at least a portion of, a computer program product. In other examples, hard wired circuitry may be used in place of or in combination with machine readable instructions to implement the functions described. For example, controller 802 may be embodied as part of at least one application-specific integrated circuit (ASIC), at least one field-programmable gate array (FPGA), and/or the like. In at least some examples, the controller 802 is not limited to any specific combination of hardware circuitry and machine readable instructions, nor limited to any particular source for the machine readable instructions executed by the controller 802.

In some examples, control portion 800 may be entirely implemented within or by a stand-alone device.

In some examples, the control portion 800 may be partially implemented in one of the object formation devices and partially implemented in a computing resource separate from, and independent of, the object formation devices but in communication with the object formation devices. For instance, in some examples control portion 800 may be implemented via a server accessible via the cloud and/or other network pathways. In some examples, the control portion 800 may be distributed or apportioned among multiple devices or resources such as among a server, an object formation device, and/or a user interface.

In some examples, control portion 800 includes, and/or is in communication with, a user interface 820 as shown in FIG. 7C. In some examples, user interface 820 comprises a user interface or other display that provides for the simultaneous display, activation, and/or operation of at least some of the additive manufacturing devices, as well as the particular portions, components, material distributors, fluid supply, fluid dispensers, energy sources, control portion, instructions, engines, functions, parameters, and/or methods, etc., as described in association with FIGS. 1-7B and 8. In some examples, at least some portions or aspects of the user interface 820 are provided via a graphical user interface (GUI), and may comprise a display 824 and input 822. As previously noted, in some examples user interface 820 may enable a user to engage the user specification engine 740 in FIG. 7A in order to select a desired value(s) of at least one thermal parameter of a 3D object (or portion thereof), values of other parameters, and/or exert control over at least some aspects of the various example methods and/or devices described throughout the present disclosure.

FIG. 8 is a flow diagram of an example method 800. In some examples, method 800 may be performed via at least some of the devices, components, material distributors, fluid supply, fluid dispensers, energy sources, instructions, control portions, engines, functions, parameters, and/or methods, etc. as previously described in association with at least FIGS. 1-7C. In some examples, method 800 may be performed via at least some of the devices, components, material distributors, fluid supply, fluid dispensers, energy sources, instructions, control portions, engines, functions, parameters, and/or methods, etc. other than those previously described in association with at least FIGS. 1-7B.

As shown at 900 in FIG. 8, method 900 comprises additively manufacturing a three-dimensional object including selectively controlling a density of build material through the three-dimensional object, on a voxel-by-voxel basis, to control at least one thermal parameter of the three-dimensional object. Based on the foregoing examples throughout the present disclosure, it will be understood that the selectively controlled density may be implemented as, or understood in relation to, a selectable porosity and/or selectable degree of fusion.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A non-transitory machine-readable storage medium, encoded with instructions executable by a processor, comprising:
instructions to generate data representing a three-dimensional object model to additively manufacture a three-dimensional object including a selectable first porosity to control at least one thermal parameter of the three-dimensional object according to a user specification.

2. The non-transitory machine readable medium of claim 1, wherein the at least one thermal parameter comprises at least one of:
a thermal conductivity;
a heat capacity; and
a specific heat capacity.

3. The non-transitory machine readable medium of claim 1, wherein the instructions are to implement the selectable first porosity according to a selectable degree of fusing the build material as at least one of:
unfused powder build material; and
at least partially fused powder build material.

4. The non-transitory machine readable medium of claim 1, wherein three-dimensional object comprises a first portion, wherein the instructions are to implement the three-dimensional object with substantially the entire first portion comprising a selectable porosity, on a voxel-by-voxel basis, to cause the at least one thermal parameter of the first portion to exhibit substantial uniformity.

5. The non-transitory machine readable medium of claim 4, comprising at least one of:
the first portion comprises the entire three-dimensional object; or
the first portion comprising an interior portion of the three-dimensional object and an exterior portion at least partially containing the interior portion, wherein the exterior portion comprises a selectable second porosity different from the selectable first porosity.

6. The non-transitory machine readable medium of claim 1, wherein at least a first portion of the three-dimensional object exhibits, via the selectable first porosity, a selectable anisotropic profile of the at least one thermal parameter within the three-dimensional object.

7. The non-transitory machine readable medium of claim 1, wherein the instructions are to implement the selectable first porosity according to a plurality of different porosity regions, each different porosity region having a different at least one thermal parameter within the three-dimensional object, wherein the different porosity regions each have at least one of a selectable volume, a selectable location, and a selectable shape.

8. The non-transitory machine readable medium of claim 1, wherein the instructions are to implement the selectable first porosity in the three-dimensional object according to a three-dimensional individually addressable array of voxels to selectively control the at least one thermal parameter on a voxel-by-voxel basis throughout at least a portion of the three-dimensional object.

9. A print control portion, comprising:
a processor programmed to additively form a 3D object including a first portion with a degree of fusion of build material determinable according to a selectively specifiable value of at least one thermal parameter of at least the first portion of the 3D object.

10. The print control portion of claim 9, wherein the print control unit is at least one of:
in communication with the 3D printer; and
incorporated as part of the 3D printer,
wherein the 3D printer comprises:
a build unit including a build platform;
a build material distributor to distribute a build material on the build platform;
a fluid dispenser to selectively apply at least one agent to the build material, the at least one agent comprising a detailing agent and a fusing agent;
an energy source to apply energy to cause fusing, via the at least one agent, of the build material to form the 3D object of the build material,
wherein the print control portion is to control at least the material distributor, the fluid dispenser, and the energy source to additively form the 3D object including the first portion according to the selectively specifiable value of at least one thermal parameter.

11. The print control portion of claim 9, wherein the processor is programmed to implement the selectable degree of fusion according to at least one of a selectable volume, a selectable location, and a selectable shape.

12. The print control portion of claim 9, wherein the programmer is to implement first portion adjacent to an embedded structural feature within the 3D object.

13. The print control unit of claim 12, wherein the processor is programmed to implement the selectable degree of fusion in the first portion to thermally complement at least one thermal behavior of the embedded structural feature.

14. A method comprising:
additively manufacturing a three-dimensional object including selectively controlling a density of build material throughout the three-dimensional object, on a voxel-by-voxel basis, to control at least one thermal parameter of the three-dimensional object.

15. The method of claim 14, comprising:
implementing the selectively controlled density of the first portion of the 3D object via controlling a proportion of at least one of:
unfused powder build material; and
at least partially fused powder build material.
